(19) United States
(12) Patent Application Publication
(10) Pub. No.: US 2021/0064334 A1
(43) Pub. Date: Mar. 4, 2021

(54) DEVICE OPERATION APPARATUS, DEVICE OPERATION SYSTEM AND DEVICE OPERATION METHOD

(71) Applicant: MITSUBISHI ELECTRIC CORPORATION, Tokyo (JP)

(72) Inventor: Masashi HIDAI, Tokyo (JP)

(73) Assignee: MITSUBISHI ELECTRIC CORPORATION, Tokyo (JP)

(21) Appl. No.: 16/960,198

(22) PCT Filed: Jan. 18, 2018
(86) PCT No.: PCT/JP2018/001426

§ 371 Date: Jul. 6, 2020

(51) Int. Cl. G06F 3/16; G10L 15/26; G06F 3/01; G10L 15/22

(52) U.S. Cl. CPC G06F 3/167; G10L 15/26; G10L 2015/223; G06F 3/013; G10L 15/22; G06F 3/012

(57) ABSTRACT

Included are: an operation information acquirer for acquiring information indicating a function of an operation target device being an operation target; an image recognition unit for calculating, from image information on an image of a user who operates the operation target device, the user's line-of-sight information; a position calculator for calculating the position of an operation target device using information transmitted from the operation target device; a voice signal acquirer for acquiring a voice signal indicating an operation instruction for operating the operation target device; an operation target device specifying unit for specifying an operation target device to be a target of the operation instruction based on the calculated line-of-sight information and the calculated position of the operation target device; and a remote controller for generating an operation command for controlling the specified operation target device based on text information corresponding to the acquired operation instruction.

### TECHNICAL FIELD

The present invention relates to a technique of operating a device on the basis of a detected line of sight.

### BACKGROUND ART

In general, a user operates a device with his/her hand or foot, but there is also a technique of operating a device using a user's line of sight without using a hand or a foot.

For example, Patent Literature 1 discloses a device operation apparatus including: a line-of-sight detection unit that detects a user's line of sight on the basis of a user image output from a line-of-sight detection camera; a motion recognition unit that recognizes a motion of the user's head on the basis of a motion of the user's neck detected by a neck motion sensor attached to the neck; a determination unit that determines an operation target device on the basis of a line of sight detected by the line-of-sight detection unit and a motion of the user's head recognized from the motion of the user's neck; a voice recognition unit that recognizes the user's voice from vibration of the user's throat detected at the user's neck by a vibration sensor of a neck-attached terminal; a device control unit that controls a device/apparatus according to determination of the determination unit; and a display unit that displays icons indicating a plurality of devices/apparatuses and an icon indicating a function to be executed by the operation target device.

The device operation apparatus calculates a line-of-sight position to which the user is directing his/her line of sight on a screen of the display unit on the basis of a user image captured by a line-of-sight detection camera while the user is directing his/her line of sight to the screen of the display unit, and determines an operation target device and operation content for the operation target device from an icon on the display unit designated by the user's line of sight on the basis of the calculated line-of-sight position.

### CITATION LIST

### Patent Literatures

Patent Literature 1: WO 2017/038248 A1

### SUMMARY OF INVENTION

### Technical Problem

In the technique disclosed in Patent Literature 1 described above, from the plurality of icons displayed on the display unit, an icon of an operation target device or an icon of a function is designated by a line of sight. However, since the position of a user or the position of an operation target device is not grasped, it is necessary to designate an operation target device to be operated by the user, and convenience of device operation is reduced disadvantageously.

The present invention has been achieved in order to solve the above-described problem, and an object of the present invention is to specify an operation target device without designation of the operation target device by a user, and to improve convenience of device operation.

### Solution to Problem

A device operation apparatus according to the present invention includes: an operation information acquisition unit for acquiring, as operation information, information indicating a function of an operation target device that is an operation target; an image recognition unit for calculating, from image information on an image of a user who operates the operation target device, the user's line-of-sight information; a position calculation unit for calculating the position of the operation target device using information transmitted from the operation target device; a voice signal acquisition unit for acquiring a voice signal indicating an operation instruction for operating the operation target device; an operation target device specifying unit for specifying, when the voice signal acquisition unit acquires a voice signal, an operation target device to be a target of the operation instruction on the basis of line-of-sight information calculated by the image recognition unit and the position of the operation target device calculated by the position calculation unit; and a control unit for generating an operation command for controlling an operation target device specified by the operation target device specifying unit on the basis of text information corresponding to an operation instruction acquired by the voice signal acquisition unit.

### Advantageous Effects of Invention

The present invention can specify an operation target device without designation of the operation target device by a user, and can improve convenience of device operation.

### BRIEF DESCRIPTION OF DRAWINGS

FIG. 1 is a diagram illustrating a configuration of a device operation system including a device operation apparatus according to a first embodiment.

FIG. 2 is a block diagram illustrating a configuration of the device operation apparatus according to the first embodiment.

FIG. 3 is a block diagram illustrating a configuration of a light emitting apparatus of a device operation system according to the first embodiment.

FIGS. 4A and 4B are diagrams illustrating an example of a hardware configuration of the device operation apparatus according to the first embodiment.

FIGS. 5A and 5B are diagrams illustrating an example of a hardware configuration of a light emitting apparatus of the device operation system according to the first embodiment.

FIG. 6 is a diagram illustrating a configuration of a position detection apparatus connected to the device operation apparatus according to the first embodiment.

FIG. 7 is an explanatory diagram illustrating reception of a light emission signal by a two-dimensional PSD.

FIG. 8 is an explanatory diagram illustrating a configuration for determining a distance between a light emitting apparatus and a two-dimensional PSD.

FIG. 9 is an explanatory diagram illustrating calculation of the position of an operation target device by a position calculation unit of the device operation apparatus according to the first embodiment.

FIG. 10 is an explanatory diagram illustrating specification of an operation target device by an operation target device specifying unit of the device operation apparatus according to the first embodiment.

FIG. 11 is a flowchart illustrating a prior information storage process by the device operation apparatus according to the first embodiment.

FIG. 12 is a sequence diagram illustrating a process of storing operation information of an operation target device in a device operation system including the device operation apparatus according to the first embodiment.

FIG. 13 is a flowchart illustrating a process in which the device operation apparatus according to the first embodiment controls an operation target device.

FIG. 14 is a sequence diagram illustrating a process of operating an operation target device in the device operation system including the device operation apparatus according to the first embodiment.

FIG. 15 is a block diagram illustrating a configuration of a device operation apparatus according to a second embodiment.

FIG. 16 is a diagram illustrating an arrangement positional relationship in a device operation system according to the second embodiment.

FIG. 17 is a diagram illustrating the position of an operation target device with respect to a device operation apparatus in the device operation system according to the second embodiment.

FIG. 18 is a flowchart illustrating a position estimation process of the device operation apparatus according to the second embodiment.

### DESCRIPTION OF EMBODIMENTS

Hereinafter, in order to describe the present invention in more detail, embodiments of the present invention will be described with reference to the attached drawings.

### First Embodiment

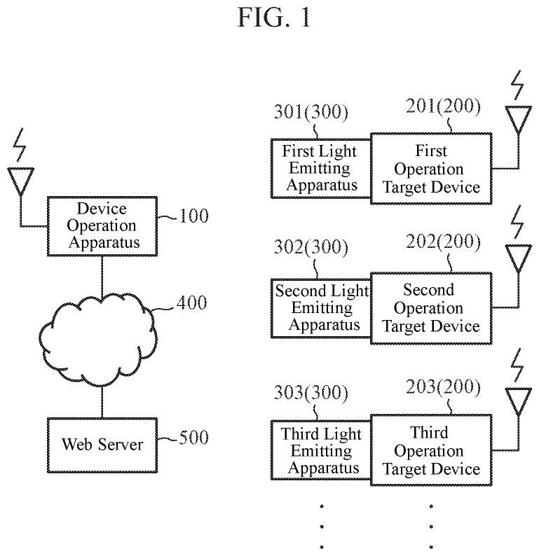

FIG. 1 is a diagram illustrating a configuration of a device operation system including a device operation apparatus 100 according to a first embodiment.

The device operation system includes the device operation apparatus 100, an operation target device 200, and a light emitting apparatus 300 connected to the operation target device 200. The device operation apparatus 100 establishes a communication connection with the operation target device 200 via an antenna or a communication line. Furthermore, the device operation apparatus 100 is connected to an external Web server 500 via a network communication network 400.

The operation target device 200 is an operation target operated on the basis of control of the device operation apparatus 100. As illustrated in FIG. 1, the operation target device 200 includes a plurality of operation target devices 200 such as a first operation target device 201, a second operation target device 202, and a third operation target device 203. The operation target device 200 is connected to the light emitting apparatus 300 that transmits a light emission signal. As illustrated in FIG. 1, a first light emitting apparatus 301 is connected to the first operation target device 201, a second light emitting apparatus 302 is connected to the second operation target device 202, and a third light emitting apparatus 303 is connected to the third operation target device 203. In FIG. 1, an example in which three operation target devices 200 and three light emitting apparatuses 300 are disposed is illustrated. However, the number of operation target devices 200 to be disposed and the number of light emitting apparatuses 300 to be disposed are not limited to three, and can be set appropriately.

The operation target device 200 receives infrared light corresponding to an operation command transmitted from the device operation apparatus 100. A wireless communication signal corresponding to the operation command transmitted from the device operation apparatus 100 is received via an antenna. The operation target device 200 executes a function on the basis of an operation command of which the operation target device 200 has been notified with the received infrared light or the received wireless communication signal. Furthermore, the operation target device 200 transmits information indicating a function as a wireless communication signal corresponding to operation information to the device operation apparatus 100 via an antenna.

The external Web server 500 has functions of executing a voice recognition process and an interactive process on a voice stream transmitted from the device operation apparatus 100 and generating text information corresponding to a voice input to the device operation apparatus 100 by a user.

The device operation system illustrated in FIG. 1 is applied to, for example, a case where a smart speaker or an AI speaker having a voice assistant function using an existing mobile communication network is used. The voice assistant function uses, for example, a service provided by a cloud service provider via the Internet.

In the following, a description will be given assuming that the operation target device 200 is disposed indoors. As illustrated in FIG. 1, different model names are assigned to the first operation target device 201, the second operation target device 202, and the third operation target device 203, and operation corresponding to each of the devices is performed.

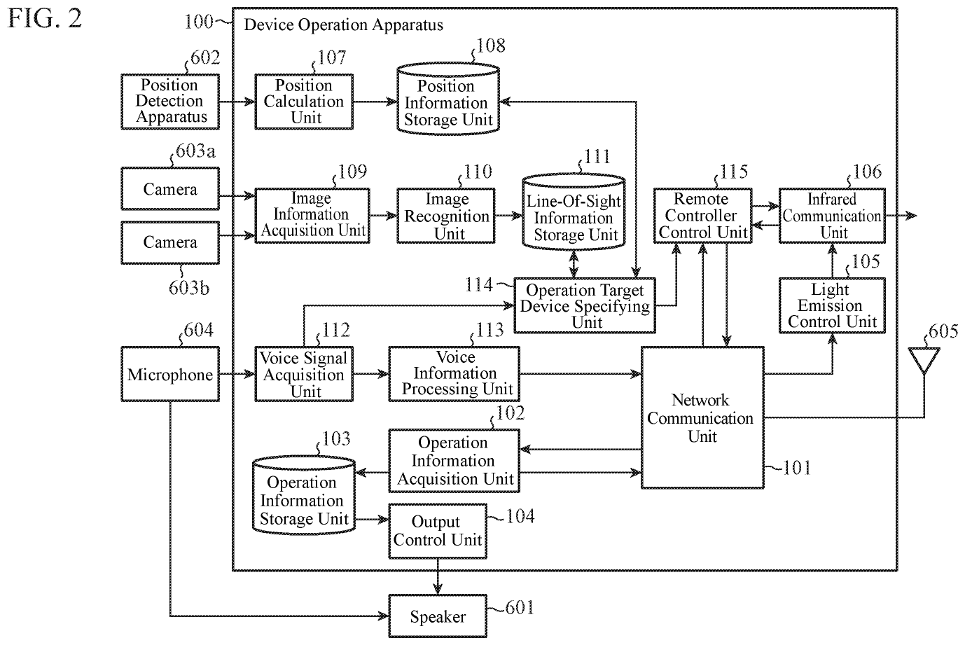

Next, a detailed configuration of the device operation apparatus 100 will be described with reference to FIG. 2.

FIG. 2 is a block diagram illustrating a configuration of the device operation apparatus 100 according to the first embodiment.

The device operation apparatus 100 includes a network communication unit 101, an operation information acquisition unit 102, an operation information storage unit 103, an output control unit 104, a light emission control unit 105, an infrared communication unit 106, a position calculation unit 107, a position information storage unit 108, an image information acquisition unit 109, an image recognition unit 110, a line-of-sight information storage unit 111, a voice signal acquisition unit 112, a voice information processing unit 113, an operation target device specifying unit 114, and a remote controller control unit (control unit) 115.

Furthermore, a speaker 601, a position detection apparatus 602, cameras 603a and 603b, a microphone 604, and an antenna 605 are connected to the device operation apparatus 100.

The network communication unit 101 transmits and receives various pieces of information handled by the device operation apparatus 100 via the antenna 605 and a communication line. For example, the network communication unit 101 performs data communication with the Web server 500 via the network communication network 400 in order to implement the Internet function of the device operation apparatus 100. Furthermore, the network communication unit 101 performs communication with the operation target device 200 by short-range wireless communication such as Bluetooth (registered trademark) or wireless communication such as WiFi (registered trademark). Furthermore, the network communication unit 101 transmits a wireless communication signal corresponding to an operation command input from the remote controller control unit 115 described later to the operation target device 200 via the antenna 605. Furthermore, the network communication unit 101 receives a wireless communication signal transmitted from the operation target device 200 via the antenna 605, and outputs information included in the received wireless communication signal to the operation information acquisition unit 102 or the remote controller control unit 115.

The operation information acquisition unit 102 acquires information indicating a function of the operation target device 200 as operation information via the network communication unit 101. Here, the information indicating a function of the operation target device 200 is information indicating content of operation that can be performed on the operation target device 200. The operation information acquisition unit 102 searches the operation target device 200 existing on the same network via the network communication unit 101, and acquires operation information from the operation target device 200 that has been found. Alternatively, the operation information acquisition unit 102 accesses the Web server 500 related to the operation target device 200 via the network communication unit 101, and acquires operation information. The Web server 500 related to the operation target device 200 is, for example, a Web server of a manufacturer that manufactures the operation target device 200. The operation information acquisition unit 102 causes the operation information storage unit 103 to store the acquired operation information.

The operation information storage unit 103 is a storage area in which operation information acquired by the operation information acquisition unit 102 is stored. Operation information stored in the operation information storage unit 103 is identification information constituted by information indicating, for example, a universally unique identifier (UUID), an address, a model name, and a function, assigned to each of the operation target devices 200 in order to identify the operation target devices 200.

The output control unit 104 refers to the operation information stored in the operation information storage unit 103 and generates control information for reading out the model name of the operation target device 200 that has been found. The output control unit 104 outputs the generated control information to the speaker 601. For example, when storage of the operation information in the operation information storage unit 103 is completed, the output control unit 104 performs control to generate and output control information for reading out the model name of the operation target device 200 described above. The speaker 601 reads out the model name of the operation target device 200 on the basis of the control information input from the output control unit 104. In accordance with the model name of the operation target device 200 having been read out, a user mounts the light emitting apparatus 300 on the operation target device 200. Note that the light emitting apparatus 300 may be mounted on the operation target device 200 in advance.

Note that in FIG. 2, the case where a readout instruction is input via the microphone 604 is illustrated, but a configuration may be illustrated in which the readout instruction is input via another input apparatus such as a touch panel, a mouse, or a keyboard. Furthermore, in FIG. 2, the case where the speaker 601 reads out the model name of the operation target device 200 is illustrated, but a configuration may be adopted in which the model name of the operation target device 200 is output via another output apparatus such as a display.

When the light emission control unit 105 receives a response indicating that the mounting of the light emitting apparatus 300 on each of the operation target devices 200 has been completed via the network communication unit 101, the light emission control unit 105 generates a light emission signal output request for requesting each of the light emitting apparatuses 300 to output a light emission signal. The light emission control unit 105 transmits the light emission signal output request to each of the light emitting apparatuses 300 via the infrared communication unit 106.

The infrared communication unit 106 includes, for example, an infrared light emitting unit such as an infrared diode and an infrared light receiving unit such as an infrared photodiode, and is a communication unit for performing infrared communication between the device operation apparatus 100 and the operation target device 200, and between the device operation apparatus 100 and the light emitting apparatus 300. The infrared communication unit 106 emits infrared light corresponding to a light emission signal output request input from the light emission control unit 105 or an operation command input from the remote controller control unit 115. The infrared communication unit 106 transmits an infrared communication signal to the operation target device 200 and the light emitting apparatus 300 by emitting infrared light. Furthermore, the infrared communication unit 106 receives the infrared communication signal transmitted from the operation target device 200 and the light emitting apparatus 300, and outputs information included in the received infrared communication signal to the remote controller control unit 115.

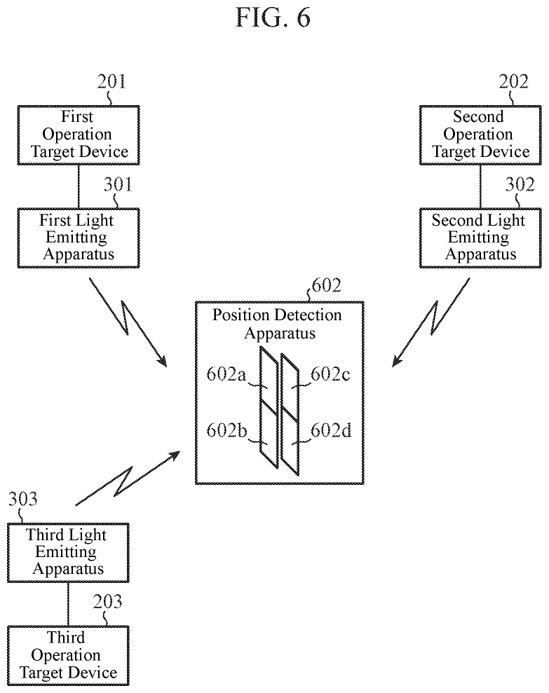

The position calculation unit 107 calculates the position of each of the operation target devices 200 using a detection output input from the position detection apparatus 602. The position detection apparatus 602 detects a light emission signal output from the light emitting apparatus 300. Here, it can be said that the light emission signal output from the light emitting apparatus 300 is information transmitted from the operation target device 200 connected to the light emitting apparatus 300. When detecting the light emission signal, the position detection apparatus 602 outputs a detection output indicating the detection of the light emission signal to the position calculation unit 107. The position detection apparatus 602 includes a position sensitive device (PSD). The position detection apparatus 602 includes, for example, four two-dimensional PSDs as illustrated in FIG. 6 described later.

When the light emission signal transmitted by the light emitting apparatus 300 is detected in the PSD of the position detection apparatus 602, the position calculation unit 107 calculates the position of the operation target device 200 on the basis of the detection output indicating the detection of the light emitting signal. The position calculation unit 107 causes the position information storage unit 108 to store the calculated position of each of the operation target devices 200 as position information. Note that the details of the position calculation unit 107 will be described later. The position information storage unit 108 is a storage area in which the position information of each of the operation target devices 200 calculated by the position calculation unit 107 is stored.

The image information acquisition unit 109 acquires image information of images captured by the cameras 603a and 603b. The image information acquisition unit 109 outputs the acquired image information to the image recognition unit 110. Here, the cameras 603a and 603b constitute a stereo camera, and can simultaneously photograph a subject from a plurality of different directions and record the position of the subject. The cameras 603a and 603b are disposed so as to be able to image the entire space in which the operation target device 200 is disposed, and photographs a user who operates the operation target device 200.

The image recognition unit 110 detects a user's face from the image information input from the image information acquisition unit 109. The image recognition unit 110 analyzes image data of the detected user's face, detects the user's face and the user's eyes, and calculates the user's face position and a line-of-sight vector indicating the user's line-of-sight direction. The image recognition unit 110 associates the calculated user's face position with the calculated line-of-sight vector and causes the line-of-sight information storage unit 111 to store the associated user's face position and line-of-sight vector as line-of-sight information. Note that the details of the image recognition unit 110 will be described later.

The line-of-sight information storage unit 111 is a storage area in which a user's face position and a line-of-sight direction vector during a preset period are stored as line-of-sight information. The cameras 603a and 603b operate all the time, and image information is continuously input from the cameras 603a and 603b to the image information acquisition unit 109 and the image recognition unit 110. The image recognition unit 110 calculates a user's face position and a line-of-sight vector from the image information continuously input, and causes the line-of-sight information storage unit 111 to store the calculated user's face position and the calculated line-of-sight vector. The line-of-sight information storage unit 111 stores a user's face position and a line-of-sight vector during a preset period.

The voice signal acquisition unit 112 acquires a voice signal indicating an operation instruction to the operation target device 200 input via the microphone 604. The voice signal acquisition unit 112 outputs the acquired voice signal to the voice information processing unit 113. Furthermore, the voice signal acquisition unit 112 notifies the operation target device specifying unit 114 of information indicating that a voice signal has been acquired and time information on the time of acquisition of the voice signal.

The voice information processing unit 113 converts the voice signal input from the voice signal acquisition unit 112 into a voice stream. The voice information processing unit 113 transmits the voice stream obtained by conversion to the external Web server 500 via the network communication unit 101 and the network communication network 400. When receiving the voice stream, the Web server 500 performs a voice recognition process and an interactive process on the received voice stream, and generates text information corresponding to the input voice signal. Here, the text information corresponding to the voice signal is information for operating the operation target device 200 corresponding to an operation instruction indicated by the voice signal. Hereinafter, the voice recognition process, the interactive process, and the text information generating process performed by the Web server 500 will be referred to as a voice assistant function. The voice assistant function performed by the Web server 500 is a service provided by, for example, a cloud service provider, and an input/output format is disclosed by each cloud service provider. Therefore, detailed description thereof is omitted.

When the operation target device specifying unit 114 is notified of the information indicating that a voice signal has been acquired and the time information by the voice signal acquisition unit 112, the operation target device specifying unit 114 refers to the position information storage unit 108 and the line-of-sight information storage unit 111, and specifies an operation target device 200 to which a user has been directing his/her line of sight as an operation target device 200 to be a target of the operation instruction. Specifically, the operation target device specifying unit 114 specifies an operation target device 200 located in the direction of the line-of-sight vector from the information indicating the position of an operation target device 200 stored in the position information storage unit 108, and the user's face position and the line-of-sight vector stored in the line-of-sight information storage unit 111.

The operation target device specifying unit 114 acquires, from the line-of-sight information storage unit 111, for example, line-of-sight information during a period obtained by going back a certain period (for example, 10 seconds) from the time at which the voice signal indicated by the time information has been acquired. In this case, the operation target device specifying unit 114 specifies an operation target device 200 to which a user has been directing his/her line of sight for a longer time among operation target devices 200 located in the direction of the line-of-sight vector. Alternatively, when a user has been directing his/her line of sight to a plurality of operation target devices 200 for a period equal to or longer than a predetermined period, the operation target device specifying unit 114 specifies an operation target device 200 to which the user has been directing his/her line of sight for a longer time in a time zone closest to the time when the voice signal has been acquired. The operation target device specifying unit 114 outputs information indicating the specified operation target device 200 to the remote controller control unit 115.

The remote controller control unit 115 acquires the text information generated by the Web server 500 via the network communication unit 101. The remote controller control unit 115 generates an operation command corresponding to control from the acquired text information. The remote controller control unit 115 transmits the generated operation command to the operation target device 200 specified by the operation target device specifying unit 114 via the network communication unit 101 or the infrared communication unit 106. Furthermore, the remote controller control unit 115 receives, from the operation target device 200, a control execution result or the like corresponding to an operation command via the network communication unit 101 or the infrared communication unit 106.

Next, a configuration of the light emitting apparatus 300 connected to the operation target device 200 illustrated in FIG. 1 will be described.

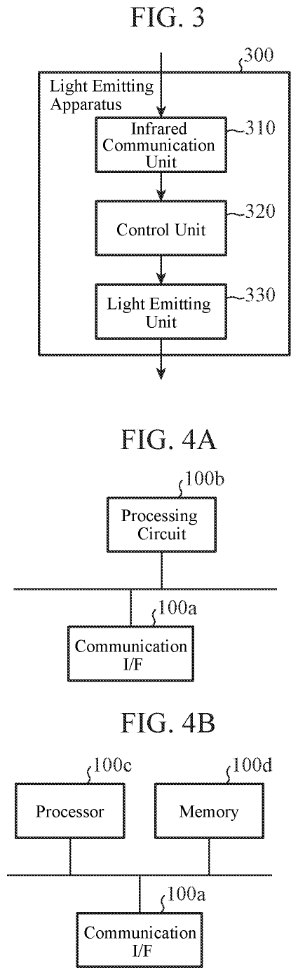

FIG. 3 is a block diagram illustrating a configuration of the light emitting apparatus 300 of the device operation system according to the first embodiment.

The light emitting apparatus 300 includes an infrared communication unit 310, a control unit 320, and a light emitting unit 330.

The infrared communication unit 310 includes, for example, an infrared light receiving unit such as an infrared sensor. The infrared communication unit 310 is a communication unit for performing infrared communication between the device operation apparatus 100 and the light emitting apparatus 300. The infrared communication unit 310 receives the infrared communication signal transmitted from the device operation apparatus 100, and outputs information included in the received infrared communication signal to the control unit 320. The control unit 320 instructs the light emitting unit 330 to transmit a light emission signal corresponding to information input from the infrared communication unit 106. The light emitting unit 330 transmits a light emission signal to the device operation apparatus 100 on the basis of an instruction from the control unit 320. The light emitting unit 330 is constituted by a light emitting body such as an LED, for example. The light emitting unit 330 can modulate the intensity of light, and the device operation apparatus 100 can thereby identify each of the plurality of light emitting apparatuses 300.

Note that in FIG. 1, the configuration in which the light emitting apparatus 300 is connected to the operation target device 200 is illustrated, but the operation target device 200 may include the components of the light emitting apparatus 300.

Next, an example of a hardware configuration of the device operation apparatus 100 will be described.

FIGS. 4A and 4B are diagrams illustrating an example of a hardware configuration of the device operation apparatus 100 according to the first embodiment.

The network communication unit 101 in the device operation apparatus 100 is achieved by a communication interface (communication I/F) 100a. Functions of the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115 in the device operation apparatus 100 are implemented by a processing circuit. That is, the device operation apparatus 100 includes a processing circuit for implementing the above functions. The processing circuit may be a processing circuit 100b that is dedicated hardware as illustrated in FIG. 4A, or a processor 100c that executes a program stored in a memory 100d as illustrated in FIG. 4B.

As illustrated in FIG. 4A, when the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115 are dedicated hardware, the processing circuit 100b may be, for example, a single circuit, a composite circuit, a programmed processor, a parallel programmed processor, an application specific integrated circuit (ASIC), a field-programmable gate array (FPGA), or a combination thereof. Each of functions of the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115 may be implemented by a processing circuit, or all of the functions of the units may be collectively implemented by one processing circuit.

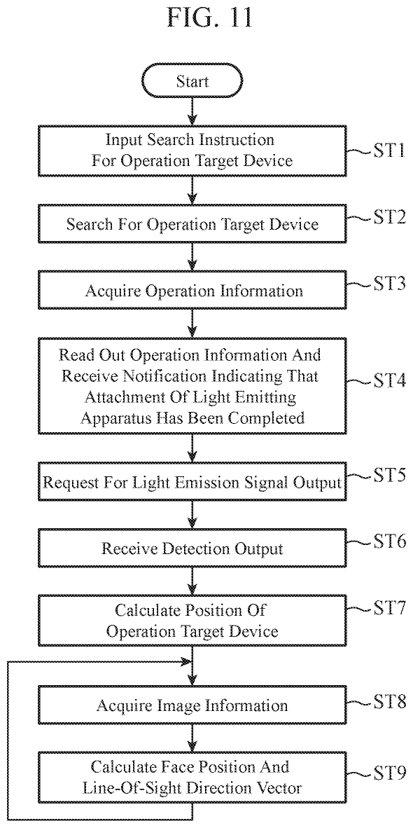

As illustrated in FIG. 4B, when the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115 constitute the processor 100c, the functions of the units are implemented by software, firmware, or a combination of software and firmware. The software or the firmware is described as a program and stored in the memory 100d. The processor 100c reads and executes a program stored in the memory 100d, and thereby implements the functions of the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115. That is, the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115 each include the memory 100d for storing a program that causes the steps illustrated in FIGS. 11 to 14 described below to be executed as a result when the program is executed by the processor 100c. It can also be said that these programs cause a computer to execute procedures or methods of the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115.

Here, the processor 100c is, for example, a central processing unit (CPU), a processing apparatus, an arithmetic apparatus, a processor, a microprocessor, a microcomputer, or a digital signal processor (DSP).

The memory 100d may be a nonvolatile or volatile semiconductor memory such as random access memory (RAM), read only memory (ROM), flash memory, erasable programmable ROM (EPROM), or electrically EPROM (EEPROM), may be a magnetic disk such as a hard disk or a flexible disk, or may be an optical disc such as a mini disc, a compact disc (CD), or a digital versatile disc (DVD).

Note that some of the functions of the operation information acquisition unit 102, the output control unit 104, the light emission control unit 105, the position calculation unit 107, the image information acquisition unit 109, the image recognition unit 110, the line-of-sight information storage unit 111, the voice signal acquisition unit 112, the voice information processing unit 113, the operation target device specifying unit 114, and the remote controller control unit 115 may be implemented by dedicated hardware, and some of the functions may be implemented by software or firmware. In this way, the processing circuit in the device operation apparatus 100 can implement the above-described functions by hardware, software, firmware, or a combination thereof.

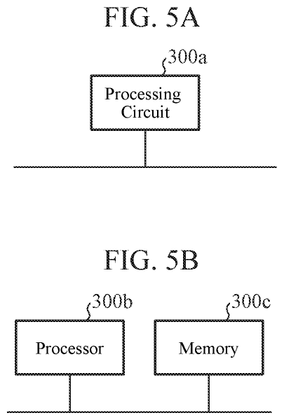

FIGS. 5A and 5B are diagrams illustrating an example of a hardware configuration of the light emitting apparatus 300 of the device operation system according to the first embodiment.

The function of the control unit 320 in the light emitting apparatus 300 is implemented by a processing circuit. That is, the light emitting apparatus 300 includes a processing circuit for implementing the above functions. The processing circuit may be a processing circuit 300a that is dedicated hardware as illustrated in FIG. 5A, or a processor 300b that executes a program stored in a memory 300c as illustrated in FIG. 5B.

As illustrated in FIG. 5B, when the control unit 320 is the processor 300b, the function of each of the units is implemented by software, firmware, or a combination of software and firmware. The software or the firmware is described as a program and stored in the memory 300c. The processor 300b reads and executes a program stored in the memory 300c, and thereby implements the function of the control unit 320. That is, the control unit 320 includes the memory 300c for storing a program that causes a process described later to be executed as a result when the program is executed by the processor 300b. It can also be said that these programs cause a computer to execute a procedure or a method of the control unit 320.

Next, detailed configurations of the image recognition unit 110, the position calculation unit 107, and the operation target device specifying unit 114 in the device operation apparatus 100 will be described. First, the image recognition unit 110 will be described.

The image recognition unit 110 detects a user's face and user's eyes with respect to image information continuously input from the image information acquisition unit 109. The image recognition unit 110 calculates a user's face position and a user's line-of-sight vector each time the user's face and the user's eyes are detected, and causes the line-of-sight information storage unit 111 to store the user's face position and the user's line-of-sight vector.

To a technique of detecting a user's face from image information and a technique of detecting a user's face orientation, various known techniques implemented in, for example, a digital camera can be applied, and therefore description thereof is omitted. A user's face and a user's face orientation may be detected by using an open source image processing library (for example, open CV or dlib).

The image recognition unit 110 detects a user's face orientation by detecting feature points of a user's face from image information, and detecting parallel movement and rotational movement which are relative movements of a user's head with respect to the cameras 603a and 603b on the basis of the detected feature points. Here, the feature points of a user's face are, for example, the end points of the left and right eyes, the apex of the nose, the right end of the mouth, the left end of the mouth, and the tip of the chin. The parallel movement of a user's head is determined from movement on the X axis, Y axis, and Z axis which are the coordinate axes of the three-dimensional coordinates set in the space where the user is located. The rotational movement of a user's head is determined from rotation about a Yow axis, a Pitch axis, and a Law axis with respect to the user's head.

The image recognition unit 110 detects a line of sight on the basis of the position of the iris that is a moving point with respect to the inner corner of the eye that is a reference point, in which the inner corner of the eye is taken as the reference point, and the iris is taken as the moving point that is a portion relatively moving with respect to the reference point in an image of the user's eye. For example, when the iris of the user's left eye is located at a position distant from the inner corner of the eye, the image recognition unit 110 detects a line of sight that the user is looking in the left direction. When the iris of the user's left eye is located at a position close to the inner corner of the eye, the image recognition unit 110 detects a line of sight that the user is looking in the right direction.

The image recognition unit 110 calculates a line-of-sight vector from detection results of the user's face orientation and user's line of sight obtained by the above-described processing. The image recognition unit 110 associates the user's face position with the user's line-of-sight vector and causes the line-of-sight information storage unit 111 to store the user's face position and the user's line-of-sight vector. The image recognition unit 110 continuously calculates the user's face position and the line-of-sight vector, and the user's face position and the line-of-sight vector for a preset period are recorded in the line-of-sight information storage unit 111 as line-of-sight information.

Next, the position calculation unit 107 will be described with reference to FIGS. 6 to 9.

FIG. 6 is a diagram illustrating a configuration of the position detection apparatus 602 connected to the device operation apparatus 100 according to the first embodiment.

In FIG. 6, a case where the position detection apparatus 602 is constituted by four two-dimensional PSDs, a first two-dimensional PSD 602a, a second two-dimensional PSD 602b, a third two-dimensional PSD 602c, and a fourth two-dimensional PSD 602d is illustrated. In FIG. 6, the first two-dimensional PSD 602a and the second two-dimensional PSD 602b receive light emission signals output from the first light emitting apparatus 301 and the third light emitting apparatus 303. Similarly, in FIG. 6, the third two-dimensional PSD 602c and the fourth two-dimensional PSD 602d receive a light emission signal output from the second light emitting apparatus 302.

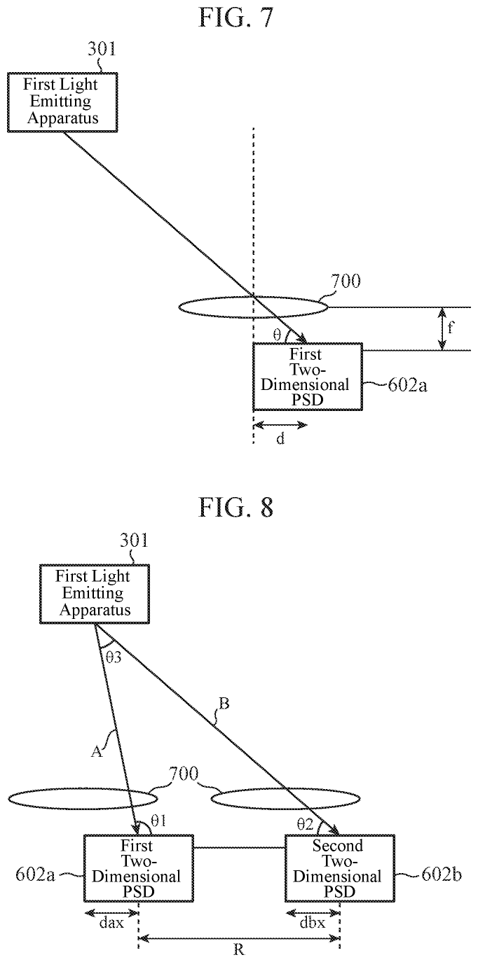

FIG. 7 is an explanatory diagram illustrating reception of a light emission signal by a two-dimensional PSD.

In FIG. 7, an example in which the first two-dimensional PSD 602a receives a light emission signal of the first light emitting apparatus 301 is illustrated. By combining the first two-dimensional PSD 602a with the first light emitting apparatus 301 and using an optical system such as a lens 700, the first two-dimensional PSD 602a can determine an incident angle θ (tan θ=f/d) of a light emission signal on the first two-dimensional PSD 602a. The incident angle θ (tan θ=f/d) of a light emission signal on the first two-dimensional PSD 602a is determined from a distance d of the center of gravity of a light spot on the first two-dimensional PSD 602a and a distance f between the lens 700 and the first two-dimensional PSD 602a.

FIG. 8 is an explanatory diagram illustrating an example of calculating a distance between the light emitting apparatus 300 and the two-dimensional PSD 602.

In FIG. 8, an example in which the first two-dimensional PSD 602a and the second two-dimensional PSD 602b receive a light emission signal transmitted by the first light emitting apparatus 301 is illustrated. In FIG. 8, the distance of the center of gravity of a light spot on the first two-dimensional PSD 602a is a distance dax, and the distance of the center of gravity of a light spot on the second two-dimensional PSD 602b is a distance dbx. A distance A between the first light emitting apparatus 301 and the first two-dimensional PSD 602a and a distance B between the first light emitting apparatus 301 and the second two-dimensional PSD 602b are determined from a distance R between the first two-dimensional PSD 602a and the second two-dimensional PSD 602b, an incident angle θ1 of a light emission signal detected by the first two-dimensional PSD 602a, and an incident angle θ2 of a light emission signal detected by the second two-dimensional PSD 602b, on the basis of the principle of triangulation.

In the case of the example in FIG. 8, the position detection apparatus 602 outputs the distance R between the first two-dimensional PSD 602a and the second two-dimensional PSD 602b and the incident angles θ1 and θ2 of light emission signals to the position calculation unit 107. The position calculation unit 107 determines the distance A between the first light emitting apparatus 301 and the first two-dimensional PSD 602a and the distance B between the first light emitting apparatus 301 and the second two-dimensional PSD 602b using the distance R between the first two-dimensional PSD 602a and the second two-dimensional PSD 602b and the incident angles θ1 and θ2 of light emission signals, input from the position detection apparatus 602, on the basis of the principle of triangulation.

The distance A and the distance B are calculated using the following formulas (1) to (4). Note that the position calculation unit 107 uses the distance A out of the determined distances A and B as a distance between the device operation apparatus 100 and the first light emitting apparatus 301.

θ3=π−(θ1+θ2) (1)

R/sin(θ3)=A/sin(θ2)=B/sin(θ1) (2)

A=R·sin(θ2)/sin(θ3) (3)

B=R·sin(θ1)/sin(θ3) (4)

Next, the position calculation unit 107 calculates the position of the operation target device 200 from the calculated distance A and the incident vector of the light emission signal from the first light emitting apparatus 301 to the position detection apparatus 602.

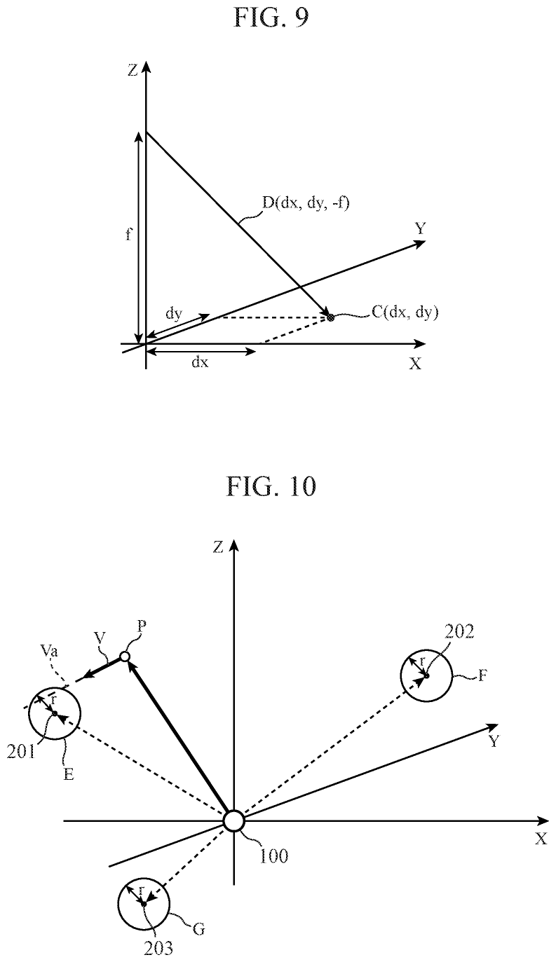

FIG. 9 is an explanatory diagram illustrating calculation of the position of the operation target device 200 by the position calculation unit 107 of the device operation apparatus 100 according to the first embodiment.

In FIG. 9, an example in which the first two-dimensional PSD 602a receives a light emission signal transmitted by the first light emitting apparatus 301 is illustrated. From the coordinates (dx, dy) of a center of gravity position C of a light spot on the first two-dimensional PSD 602a input from the position detection apparatus 602 and the distance f between the lens 700 and the first two-dimensional PSD 602a, the position calculation unit 107 acquires an incident vector D (dx, dy, −f) from the light emitting apparatus 300 on the first position detection apparatus 602a. From the acquired incident vector D and the calculated distance A, the position calculation unit 107 calculates the position of the first operation target device 201 when the device operation apparatus 100 is set as the origin.

The position calculation unit 107 calculates the position of the first operation target device 201 on the basis of the following formulas (5) and (6) in which the vector coordinates of the incident vector D (dx, dy, −f) are represented by (dx, dy, dz), a distance between the device operation apparatus 100 and the first light emitting apparatus 301 is represented by A, and the coordinates of the first operation target device 201 are represented by (X, Y, Z).

dx:dy:dz=X:Y:Z (5)

A²=X²+Y²+Z² (6)

The position calculation unit 107 causes the position information storage unit 108 to store the position of the first operation target device 201 calculated by the above-described processing as position information. Similarly, the position calculation unit 107 calculates the positions of the other operation target devices 200 and causes the position information storage unit 108 to store the positions of the other operation target devices 200. The position calculation unit 107 calculates the position information of each of the operation target devices 200 again and causes the position information storage unit 108 to store the position information every time the position of the device operation apparatus 100 changes due to movement or the like.

Next, the operation target device specifying unit 114 will be described with reference to FIG. 10.

FIG. 10 is an explanatory diagram illustrating specification of the operation target device 200 by the operation target device specifying unit 114 of the device operation apparatus 100 according to the first embodiment.

In FIG. 10, an example is illustrated in which an operation target device 200 visually recognized by a user, that is, an operation target device 200 operated by the user is specified among the first operation target device 201, the second operation target device 202, and the third operation target device 203.

When the operation target device specifying unit 114 is notified of the information indicating that a voice signal has been acquired and the time information by the voice signal acquisition unit 112, the operation target device specifying unit 114 acquires information stored in the position information storage unit 108 and indicating the positions of the first operation target device 201, the second operation target device 202, and the third operation target device 203, and acquires line-of-sight information corresponding to the time information stored in the line-of-sight information storage unit 111. The operation target device specifying unit 114 specifies an operation target device 200 operated by a user with voice on the basis of the information indicating the positions and the line-of-sight information. The process in which the operation target device specifying unit 114 specifies an operation target device 200 will be described in more detail.

The operation target device specifying unit 114 sets three-dimensional coordinates with the device operation apparatus 100 as the origin, as illustrated in FIG. 10. Next, the operation target device specifying unit 114 refers to the position information stored in the position information storage unit 108, and sets spheres E, F, and G with a radius r, centered around each center of the first operation target device 201, the second operation target device 202, and the third operation target device 203. The radius r is appropriately set on the basis of the resolution of the camera 603, the performance of the PSD, and the like.

Next, the operation target device specifying unit 114 acquires a user's face position P and a user's line-of-sight vector V at the time when a user performs operation from the line-of-sight information storage unit 111 on the basis of the time information of which the voice signal acquisition unit 112 has notified the operation target device specifying unit 114. In the three-dimensional coordinates with the device operation apparatus 100 as the origin, the operation target device specifying unit 114 determines whether or not a straight line Va extending the user's line-of-sight vector V from the acquired user's face position P intersects with one of the set spheres E, F, and G with the radius r.

The operation target device specifying unit 114 performs coordinate conversion of the user's line-of-sight vector V into a coordinate system having the user's face position P as the origin in the process of determining whether the straight line Va intersects with one of the spheres E, F, and G. The line-of-sight vector V after conversion becomes a vector passing through the origin of the coordinate system, and intersection of a line segment Va extending the line-of-sight vector V after conversion with each of the spheres E, F, and G with the radius r is determined by calculation. The intersection of the line segment Va with each of the spheres E, F, and G is determined by determining intersection of a line segment obtained by projecting the line segment Va on the X-Y plane with a circle, intersection of a line segment obtained by projecting the line segment Va on the Y-Z plane with a circle, and intersection of a line segment obtained by projecting the line segment Va on the Z-X plane with a circle. Note that the conditions under which a line segment intersects with a circle are known, and therefore description thereof is omitted here.

In the example of FIG. 10, the operation target device specifying unit 114 determines that the straight line Va intersects with the sphere E, and specifies that the first operation target device 201 associated with the sphere E is an operation target device 200 visually recognized by a user. In the example of FIG. 10, if the straight line Va intersects with the plurality of spheres E, F, and G, the operation target device specifying unit 114 reduces the set radius r at a fixed ratio, and determines again whether or not each of the spheres Ea, Fa, Ga (not illustrated) with a reduced radius ra intersects with the line segment Va. When the radius r is reduced to a value equal to or less than a certain value, but the line segment Va intersects with the plurality of spheres, the operation target device specifying unit 114 determines that overlapping operation target devices 200 exist in the same line-of-sight direction and an operation target device 200 cannot to be uniquely determined. When the operation target device 200 cannot be uniquely determined, the operation target device specifying unit 114 specifies, for example, an operation target device 200 having the shortest distance from a user as an operation target device 200 visually recognized by the user.

When acquiring line-of-sight information from the line-of-sight information storage unit 111, the operation target device specifying unit 114 refers to the time information of which the voice signal acquisition unit 112 has notified the operation target device specifying unit 114, and acquires a user's face position P and a user's line-of-sight vector V that are line-of-sight information during a period obtained by going back a certain period from the time at which a voice signal has been acquired. When the operation target device 200 cannot be uniquely determined on the basis of the line-of-sight information during a period obtained by going back a certain period from the time at which a voice signal has been acquired, the operation target device specifying unit 114 specifies an operation target device 200 to which a user has been directing his/her line of sight for a longer time as an operation target device 200 visually recognized by the user. When a user has been directing his/her line of sight to a plurality of operation target devices 200 for a period equal to or longer than a predetermined period, the operation target device specifying unit 114 specifies an operation target device 200 to which the user has been directing his/her line of sight for a longer time in a time zone closest to the time when the voice signal has been acquired as an operation target device 200 visually recognized by the user. The operation target device specifying unit 114 outputs information indicating the specified operation target device 200 to the remote controller control unit 115.

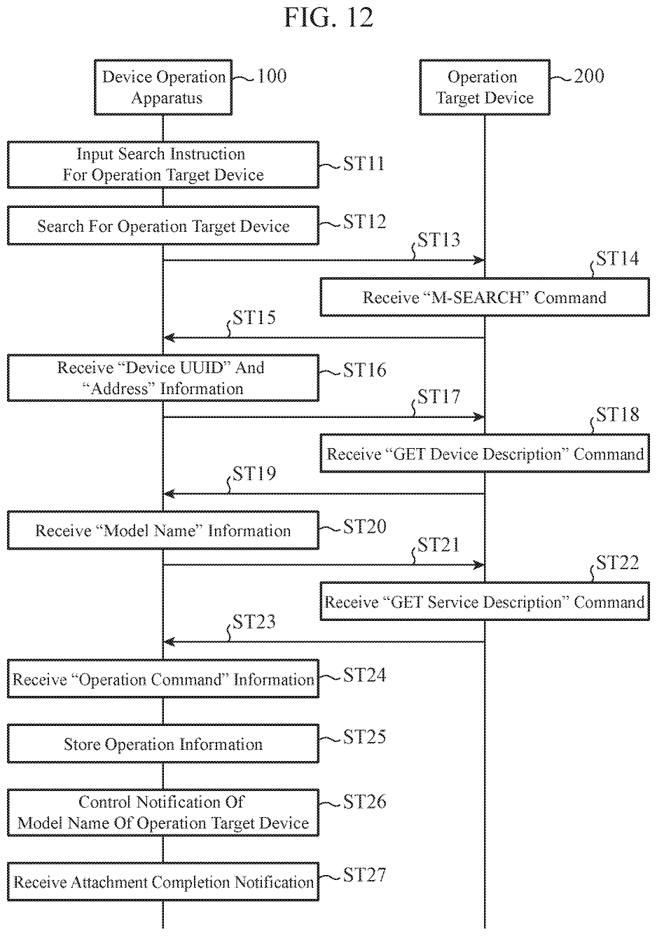

Next, operation of the device operation apparatus 100 will be described. The operation of the device operation apparatus 100 will be described separately for a process of storing various pieces of information in advance and a process of controlling the operation target device 200 on the basis of user's voice. First, the process in which the device operation apparatus 100 stores various pieces of information in advance will be described with reference to the flowchart of FIG. 11 and the sequence diagram of FIG. 12.

FIG. 11 is a flowchart illustrating a prior information storage process by the device operation apparatus 100 according to the first embodiment.

When a search instruction for the operation target device 200 is input to the device operation apparatus 100 (step ST1), the operation information acquisition unit 102 searches for the operation target device 200 in response to the search instruction input in step ST1 via the network communication unit 101 (step ST2). The operation information acquisition unit 102 acquires operation information of the operation target device 200 searched for in step ST2, and causes the operation information storage unit 103 to store the operation information (step ST3).

When the output control unit 104 reads out the operation information stored in the operation information storage unit 103 and the light emission control unit 105 receives a notification indicating that mounting of the light emitting apparatuses 300 has been completed via the network communication unit 101 (step ST4), the light emission control unit 105 transmits a light emission signal output request to each of the light emitting apparatuses 300 via the infrared communication unit 106 (step ST5). The position calculation unit 107 receives, from the position detection apparatus 602, an input of a detection output indicating that the light emission signal transmitted from the light emitting apparatus 300 has been detected in response to the light emission signal output request transmitted in step ST5 (step ST6). The position calculation unit 107 calculates the position of each of the operation target devices 200 from the detection output received from the position detection apparatus 602, and causes the position information storage unit 108 to store the position as position information (step ST7).

Next, the image information acquisition unit 109 acquires image information from the cameras 603a and 603b (step ST8). The image information acquisition unit 109 outputs the acquired image information to the image recognition unit 110. The image recognition unit 110 detects user's face data from the image information acquired in step ST8, analyzes the detected user's face data, and calculates a user's face position and a user's line-of-sight vector (step ST9). The image recognition unit 110 causes the line-of-sight information storage unit 111 to store the user's face position and the user's line-of-sight vector calculated in step ST9 as line-of-sight information. Thereafter, the flowchart returns to the process in step ST8, and the device operation apparatus 100 continues a process of acquiring the line-of-sight information.

Next, the processes from steps ST1 to ST4 illustrated in the flowchart of FIG. 11 will be described with reference to the sequence diagram of FIG. 12.

FIG. 12 is a sequence diagram illustrating a process of storing operation information of the operation target device 200 in a device operation system including the device operation apparatus 100 according to the first embodiment.

Note that the following description will be made by assuming that the device operation apparatus 100 and the operation target device 200 exist on the same network, and the operation target device 200 performs acquisition and operation of the operation information of the operation target device 200 by wireless communication using the mechanism of digital living network alliance (DLNA, a registered trademark (hereinafter, not described)).

When the search instruction for the operation target device 200 input by a user via an input apparatus (not illustrated) is input to the device operation apparatus 100 (step ST11), the operation information acquisition unit 102 of the device operation apparatus 100 searches for the operation target device 200 existing on the same network via the network communication unit 101 on the basis of the input search instruction (step ST12). The operation information acquisition unit 102 transmits an “M-SEARCH” command in DLNA to the operation target device 200 that has been found for in step ST12 via the network communication unit 101 (step ST13). When receiving the command transmitted in step ST13 (step ST14), the operation target device 200 transmits information of “Device UUID” and “address” corresponding to the command to the device operation apparatus 100 (step ST15).

When receiving the information transmitted in step ST15 via the network communication unit 101 (step ST16), the operation information acquisition unit 102 of the device operation apparatus 100 transmits a “GET Device Description” command in the DLNA to the operation target device 200 via the network communication unit 101 (step ST17). When receiving the command transmitted in step ST17 (step ST18), the operation target device 200 transmits information of “model name” corresponding to the command to the device operation apparatus 100 (step ST19).

When receiving the information transmitted in step ST19 via the network communication unit 101 (step ST20), the operation information acquisition unit 102 of the device operation apparatus 100 transmits a “GET Service Description” command in the DLNA to the operation target device 200 via the network communication unit 101 (step ST21). When receiving the command transmitted in step ST21 (step ST22), the operation target device 200 transmits information of “operation command” corresponding to the command to the device operation apparatus 100 (step ST23). The operation information acquisition unit 102 of the device operation apparatus 100 receives the command transmitted in step ST23 via the network communication unit 101 (step ST24).

The operation information acquisition unit 102 causes the operation information storage unit 103 to store the information received in steps ST16, ST20, and ST24 as operation information (step ST25). The output control unit 104 performs control to notify a user of the model name of the operation target device 200 stored in the operation information storage unit 103 (step ST26). The control of notifying a user of the model name of the operation target device 200 is, for example, control of reading out the model name of the operation target device 200 via the speaker 601. When a user mounts the light emitting apparatus 300 on the operation target device 200 having been read out, on the basis of the notification in step ST26, the device operation apparatus 100 receives a mounting completion notification of the light emitting apparatus 300 (step ST27), and ends the process. Note that the processes from steps ST13 to ST25 illustrated in FIG. 12 are repeatedly performed for all the operation target devices 200 that have been found for in step ST12.

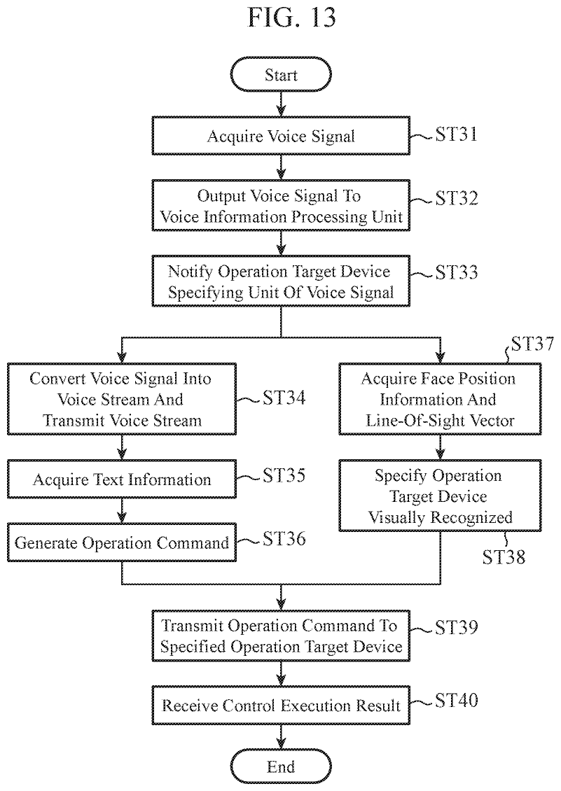

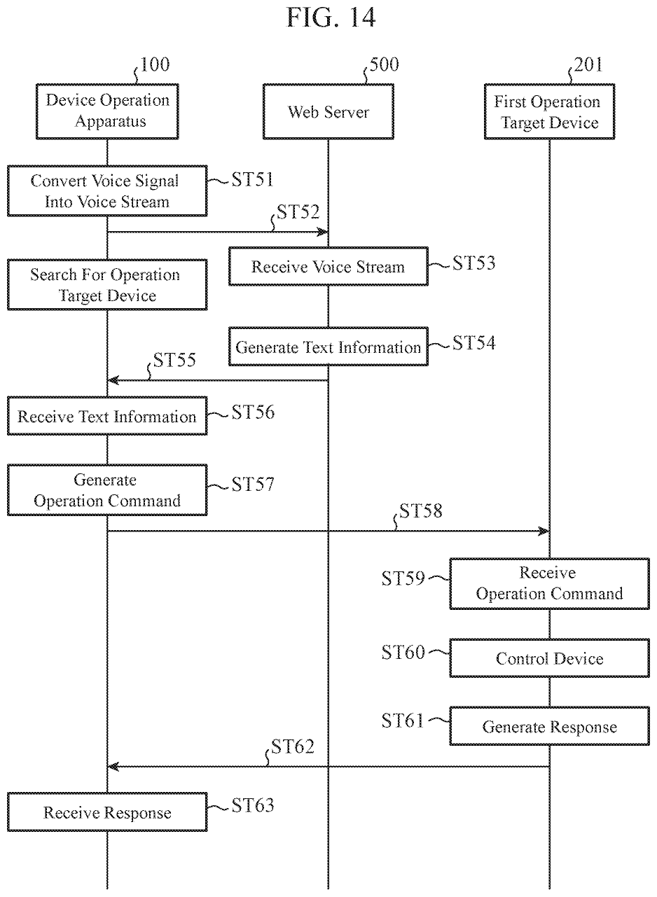

Next, a process in which the device operation apparatus 100 controls the operation target device 200 on the basis of user's voice will be described with reference to the flowchart of FIG. 13 and the sequence diagram of FIG. 14.

Note that hereinafter, a case where a user operates a television as the operation target device 200 with voice will be described as an example. For example, the first operation target device 201 is a television having a model name of “AAA”, and performs power ON or power OFF operation and channel switching operation. A user utters a start word for operating a television “OK, Alex” at the beginning of a voice input while watching the television which is the first operation target device 201, and starts operation of the first operation target device 201. Hereinafter, a case where a user utters “OK, Alex, increase the volume of the television” will be described as an example, but the utterance of the user is not limited thereto.

FIG. 13 is a flowchart illustrating a process in which the device operation apparatus 100 according to the first embodiment controls the first operation target device 201.

When acquiring a voice signal of the utterance “OK, Alex, increase the volume of the television” from the microphone 604 (step ST31), the voice signal acquisition unit 112 outputs the acquired voice signal to the voice information processing unit 113 (step ST32), and notifies the operation target device specifying unit 114 of information indicating that the voice signal has been received and time information (step ST33). The voice information processing unit 113 converts the voice signal input in step ST32 into a voice stream and transmits the voice stream to the outside via the network communication unit 101 (step ST34). The remote controller control unit 115 acquires text information corresponding to the voice stream transmitted in step ST34 via network communication unit 101 (step ST35). The remote controller control unit 115 generates an operation command corresponding to operation on the basis of the text information acquired in step ST35 (step ST36).

Meanwhile, when being notified of the input of the information indicating that the voice signal has been received and the time information in step ST33, the operation target device specifying unit 114 refers to the line-of-sight information storage unit 111 and acquires user's face position information and a line-of-sight vector during a period obtained by going back a certain period from the time at which the voice signal has been acquired (step ST37). The operation target device specifying unit 114 specifies the first operation target device 201 that is an operation target device visually recognized by the user on the basis of the user's face position information and line-of-sight vector acquired in step ST37, and the position information of the operation target device 200 stored in the position information storage unit 108 (step ST38). The operation target device specifying unit 114 outputs information indicating the first operation target device 201 specified in step ST38 to the remote controller control unit 115.

The remote controller control unit 115 transmits the operation command generated in step ST36 to the first operation target device 201 specified in step ST38 via the infrared communication unit 106 (step ST39). In this example, an operation command to request an increase in volume is transmitted to the television being watched by the user. The remote controller control unit 115 receives a control execution result or the like corresponding to the operation command transmitted in step ST39 from the first operation target device 201 via the infrared communication unit 106 (step ST40), and ends the process.

Next, the processes from steps ST34 to ST36, ST39, and ST40 illustrated in the flowchart of FIG. 13 will be described with reference to the sequence diagram of FIG. 14.

FIG. 14 is a sequence diagram illustrating a process in which the device operation system according to the first embodiment controls the first operation target device 201 on the basis of user's voice.

The voice information processing unit 113 of the device operation apparatus 100 converts a voice signal input from the voice signal acquisition unit 112 into a voice stream (step ST51). The voice information processing unit 113 transmits the voice stream obtained by conversion in step ST51 to the Web server 500 of a service provider providing a voice assistant function via the network communication unit 101 (step ST52). When receiving the voice stream transmitted in step ST52 (step ST53), the Web server 500 generates text information on operation from the received voice stream (step ST54). The Web server 500 transmits the text information generated in step ST54 to the device operation apparatus 100 (step ST55).

When receiving the text information transmitted in step ST55 via the network communication unit 101 (step ST56), the remote controller control unit 115 of the device operation apparatus 100 generates an operation command corresponding to the text information (step ST57). In this example, in step ST57, an operation command to request an increase in volume of the television is generated. The remote controller control unit 115 transmits the operation command generated in step ST57 to the first operation target device 201 specified by the operation target device specifying unit 114 via the infrared communication unit 106 (step ST58).

When receiving the operation command transmitted in step ST58 (step ST59), the first operation target device 201 performs control to increase the volume corresponding to the received operation command (step ST60). The first operation target device 201 generates a response indicating that the volume has been increased corresponding to the operation command (step ST61). The first operation target device 201 transmits the response generated in step ST61 to the device operation apparatus 100 (step ST62). The remote controller control unit 115 of the device operation apparatus 100 receives the response transmitted in step ST62 via the network communication unit 101 (step ST63), and ends the process.

As described above, the device operation apparatus 100 according to the first embodiment includes: the operation information acquisition unit 102 for acquiring, as operation information, information indicating a function of the operation target device 200 that is an operation target; the image recognition unit 110 for calculating, from image information on an image of a user who operates the operation target device 200, the user's line-of-sight information; the position calculation unit 107 for calculating the position of the operation target device 200 using information transmitted from the operation target device 200; the voice signal acquisition unit 112 for acquiring a voice signal indicating an operation instruction for operating the operation target device 200; the operation target device specifying unit 114 for specifying, when a voice signal is acquired, the operation target device 200 to be a target of the operation instruction on the basis of line-of-sight information calculated by the image recognition unit 110 and the position of the operation target device 200 calculated by the position calculation unit 107; and the remote controller control unit 115 for generating an operation command for controlling the operation target device 200 specified by the operation target device specifying unit 114 on the basis of text information corresponding to an operation instruction.

This makes it possible to specify the operation target device 200 visually recognized by a user. This makes it possible to omit the process in which a user designates the operation target device 200 when the user operates the operation target device 200, and to improve convenience during operation of the operation target device.

Furthermore, the device operation apparatus 100 according to the first embodiment includes the line-of-sight information storage unit 111 for storing user's line-of-sight information calculated by the image recognition unit 110 for a preset period, and the operation target device specifying unit 114 refers to the stored line-of-sight information and specifies an operation target device located in the direction of a user's line-of-sight vector as an operation target device to be a target of the operation instruction.

This makes it possible to appropriately determine the operation target device 200 even when a user removes his/her eyes from the operation target device 200 which the user has viewed at the time of the operation instruction.

Furthermore, in the device operation apparatus 100 according to the first embodiment, the operation target device specifying unit 114 refers to stored line-of-sight information, and specifies an operation target device located in the direction of a user's line-of-sight vector during a period obtained by going back a certain period from the time at which the voice signal acquisition unit 112 has acquired a voice signal as an operation target device to be a target of the operation instruction.

As a result, before a user gives an operation instruction, by specifying an operation target device from the length of a period during which the user has visually recognized an operation target device that is an operation target, an operation target device visually recognized by the user can be specified appropriately.

### Second Embodiment

A second embodiment indicates a configuration in which, when a device operation apparatus is moved, for example, when a shield exists between the device operation apparatus and an operation target device, and the device operation apparatus cannot grasp the position of the operation target device, the position of the shielded operation target device is determined using position information of another operation target device.

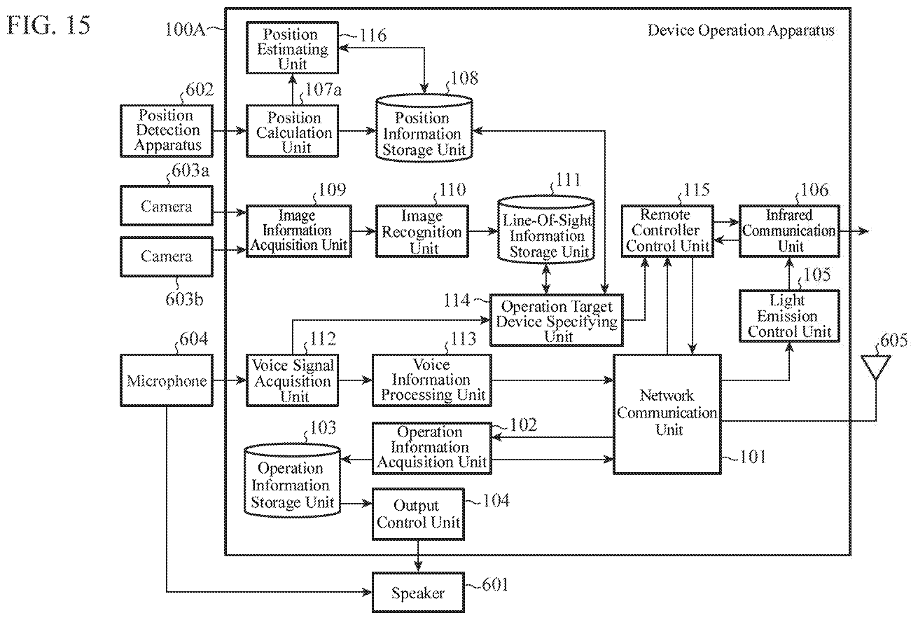

FIG. 15 is a block diagram illustrating a configuration of a device operation apparatus 100A according to the second embodiment.

The device operation apparatus 100A is configured by adding a position estimating unit 116 to the device operation apparatus 100 of the first embodiment illustrated in FIG. 2. Furthermore, the device operation apparatus 100A is configured by disposing a position calculation unit 107a instead of the position calculation unit 107 in the first embodiment.

In the following, portions that are the same as or correspond to the components of the device operation apparatus 100 according to the first embodiment are denoted by the same reference numerals as those used in the first embodiment, and description thereof is omitted or simplified.

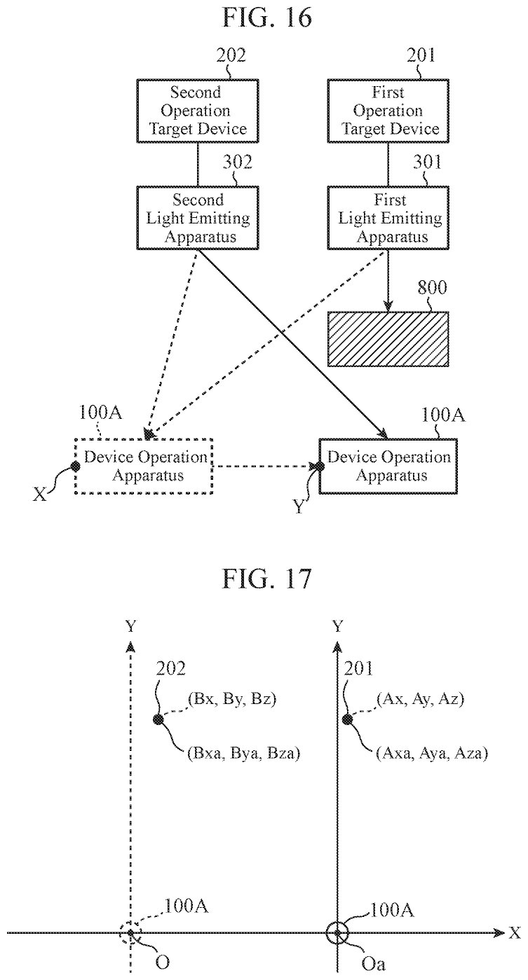

FIG. 16 is an explanatory diagram illustrating an outline of a process of the device operation apparatus 100A according to the second embodiment.

When the device operation apparatus 100A is moved, the position of a user and the position of an operation target device 200 as viewed from the device operation apparatus 100A change. For example, as illustrated in FIG. 16, when the device operation apparatus 100A is moved from a position X to a position Y, a shield 800 is located between the device operation apparatus 100A and a first operation target device 201. Therefore, the device operation apparatus 100A cannot receive a light emission signal transmitted by a first light emitting apparatus 301 connected to the first operation target device 201. The device operation apparatus 100A estimates the position of the first operation target device 201 using the position of a second operation target device 202 not affected by the shield 800. Note that in FIG. 16, it is assumed that the first operation target device 201 and the second operation target device 202 do not move.

The position calculation unit 107a calculates the position of the operation target device 200 on the basis of an input detection output and stores information indicating the position of the operation target device 200 in a position information storage unit 108 as in the first embodiment. The position calculation unit 107a determines whether or not detection outputs of all the operation target devices 200 have been input. When the detection outputs of all the operation target devices 200 have not been input, the position calculation unit 107a notifies the position estimating unit 116 of an operation target device 200 whose detection output has not been input (hereinafter, referred to as non-detected operation target device).

When being notified of a non-detected operation target device 200 from the position calculation unit 107a, the position estimating unit 116 acquires the previous position information of the non-detected operation target device 200 from the position information storage unit 108. Furthermore, the position estimating unit 116 acquires, from the position information storage unit 108, the current and previous position information of an operation target device 200 whose detection output has been input. The position estimating unit 116 estimates the current position of a non-detected operation target device 200 using the acquired current and previous position information of the operation target device 200 and the previous position information of the non-detected operation target device 200. The position estimating unit 116 causes the position information storage unit 108 to store the estimated current position of the non-detected operation target device 200 as position information.

Detailed processing operation of the position estimating unit 116 will be described with reference to FIG. 17.

FIG. 17 is a diagram illustrating estimation of the position of a non-detected operation target device of the device operation apparatus 100A according to the second embodiment.

The position estimating unit 116 calculates a movement amount of the first operation target device 201 and a movement amount of the second operation target device 202 as viewed from the device operation apparatus 100A using the position of the device operation apparatus 100A as the origin. In FIG. 17, the origin O is the origin of the device operation apparatus 100A before the movement, and the origin Oa is the origin of the device operation apparatus 100A after the movement. The coordinates (Bx, By, Bz) of the second operation target device 202 as viewed from the origin O are the coordinates before the movement. The coordinates (Bxa, Bya, Bza) of the second operation target device 202 as viewed from the origin Oa are the coordinates after the movement. The movement amount of the second operation target device 202 as viewed from the device operation apparatus 100A is (Bxa−Bx, Bya−By, Bza−Bz).

Next, when the coordinates of the first operation target device 201 before the movement as viewed from the origin O are represented by (Ax, Ay, Az), and the coordinates of the first operation target device 201 after the movement as viewed from the origin Oa are represented by (Axa, Aya, Aza), the coordinates of the first operation target device 201 after the movement are determined on the basis of the following formulas (7) and (8).

Axa−Ax=Bxa−Bx

Aya−Ay=Bya−By

Aza−Az=Bza−Bz (7)

Axa=Bxa−Bx+Ax

Aya=Bya−By+Ay

Aza=Bza−Bz+Az (8)

As described above, even when the first operation target device 201 is shielded by the shield 800 and a detection output of the first operation target device 201 is not input to the position calculation unit 107a of the device operation apparatus 100A, if the coordinates of any one of the operation target devices 200 (the second operation target device 202 in the example of FIG. 17) before and after the movement are obtained, the position estimating unit 116 can estimate the current coordinates of a non-detected operation target device 200 (the first operation target device 201 in the example of FIG. 17).

Next, an example of a hardware configuration of the device operation apparatus 100A will be described. Note that the description of the same configuration as that of the device operation apparatus 100 of the invention according to the first embodiment is omitted.

Each of the position calculation unit 107a and the position estimating unit 116 in the device operation apparatus 100A is a processing circuit 100b illustrated in FIG. 4A or a processor 100c that executes a program stored in a memory 100d illustrated in FIG. 4B.

Next, operation of the device operation apparatus 100A according to the second embodiment will be described.

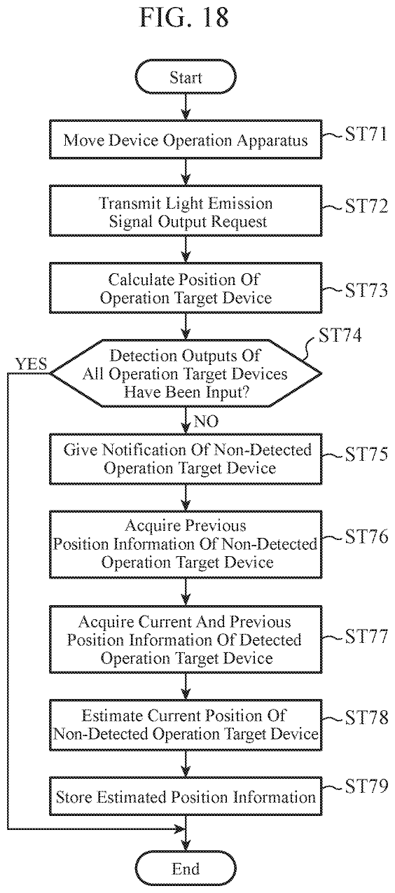

FIG. 18 is a flowchart illustrating a position estimation process of the device operation apparatus 100A according to the second embodiment. Note that in the following, a non-detected operation target device 200 is referred to as the first operation target device 201 illustrated in FIGS. 16 and 17.

When the device operation apparatus 100A is moved (step ST71), a light emission control unit 105 transmits a light emission signal output request to each of the operation target devices 200 via an infrared communication unit 106 (step ST72). When a detection output is input from the position detection apparatus 602, the position calculation unit 107a calculates the position of each of the operation target devices 200, and causes the position information storage unit 108 to store the position as position information (step ST73). The position calculation unit 107a determines whether or not detection outputs of all the operation target devices 200 have been input (step ST74). If the detection outputs of all the operation target devices 200 have been input (step ST74; YES), the process is ended.

Meanwhile, if the detection outputs of all the operation target devices 200 have not been input (step ST74; NO), the position calculation unit 107a notifies the position estimating unit 116 of the non-detected first operation target device 201 whose detection output has not been input (step ST75). The position estimating unit 116 acquires, from the position information storage unit 108, the previous position information of the non-detected first operation target device 201 whose notification has been given in step ST75 (step ST76). Furthermore, the position estimating unit 116 acquires, from the position information storage unit 108, the current and previous position information of the detected operation target device 200 other than the non-detected first operation target device 201 (step ST77). The position estimating unit 116 estimates the current position of the non-detected first operation target device 201 using the position information acquired in step ST76 and the position information acquired in step ST77 (step ST78). The position estimating unit 116 causes the position information storage unit 108 to store the position information indicating the current position of the non-detected first operation target device 201 estimated in step ST78 (step ST79), and ends the process.

As described above, the second embodiment includes the position estimating unit 116 for estimating the position of the operation target device 200 whose position cannot be calculated on the basis of the position of another operation target device 200 whose position can be calculated by the position calculation unit 107 when the position calculation unit 107 cannot calculate the position of any one of the operation target devices 200.

As a result, even when the positions of some of the operation target devices are not detected due to movement of the device operation apparatus, the position of a non-detected operation target device can be estimated using the position of another operation target device. This makes it possible to suppress a decrease in operability when a user operates an operation target device due to movement of a device operation apparatus.

In the present invention, the embodiments can be freely combined with one another, any component in the embodiments can be modified, or any component in the embodiments can be omitted within the scope of the present invention.

### INDUSTRIAL APPLICABILITY

The device operation apparatus according to the present invention is suitable for use, for example, in a device operation system that accurately grasps an operation target device operated by user's voice and operates the operation target device with voice in an environment using a smart speaker or an AI speaker.

### REFERENCE SIGNS LIST

100: Device operation apparatus, 101: Network communication unit, 102: Operation information acquisition unit, 103: Operation information storage unit, 104: Output control unit, 105: Light emission control unit, 106: Infrared communication unit, 107, 107a: Position calculation unit, 108: Position information storage unit, 109: Image information acquisition unit, 110: Image recognition unit, 111: Line-of-sight information storage unit, 112: Voice signal acquisition unit, 113: Voice information processing unit, 114: Operation target device specifying unit, 115: Remote controller control unit, 116: Position estimating unit, 200: Operation target device, 201: First operation target device, 202: Second operation target device, 203: Third operation target device, 300: Light emitting apparatus, 301: First light emitting apparatus, 302: Second light emitting apparatus, 303: Third light emitting apparatus, 400: Network communication network, 500: Web server

1. A device operation apparatus comprising:
processing circuitry to
acquire, as operation information, information indicating a function of at least one operation target device including a plurality of operation target devices that are operation targets;
calculate, from image information on an image of a user who operates the plurality of operation target devices, the user's line-of-sight information;
calculate a position of each of the plurality of operation target devices using information transmitted from the plurality of operation target devices;
store position information of each of the calculated operation target devices;
acquire a voice signal indicating an operation instruction for operating each of the plurality of operation target devices;
specify, when the processing circuitry acquires the voice signal, the at least one operation target device to be a target of the operation instruction on a basis of the calculated line-of-sight information and position information of each of the operation target devices, the position information being calculated and stored; and
generate an operation command for controlling the specified at least one operation target device on a basis of text information corresponding to the acquired operation instruction.

2. The device operation apparatus according to claim 1,
wherein the processing circuitry calculates a position of the at least one operation target device on a basis of a light emission signal transmitted from a light emitting apparatus associated with the at least one operation target device.

3. The device operation apparatus according to claim 1,
wherein the processing circuitry further estimates, when the processing circuitry fails to calculate a first position of one of the plurality of operation target devices, the first position of one operation target device that the processing circuitry fails to calculate, on a basis of second positions of the plurality of operation target devices, the second positions being successfully calculated.

4. The device operation apparatus according to claim 1,
wherein the processing circuitry further stores the user's line-of-sight information calculated for a preset period,
wherein the processing circuitry refers to the stored line-of-sight information and specifies the at least one operation target device located in a direction of the user's line-of-sight vector as an operation target device to be a target of the operation instruction.

5. The device operation apparatus according to claim 4,
wherein the processing circuitry refers to the stored line-of-sight information and specifies the at least one operation target device located in a direction of the user's line-of-sight vector during a period obtained by going back a certain period from a time at which the processing circuitry has acquired the voice signal as an operation target device to be a target of the operation instruction.

6. The device operation apparatus according to claim 5,
wherein the processing circuitry specifies, when the plurality of operation target devices is located in a direction of the user's line-of-sight vector, the at least one operation target device located in the direction of the user's line-of-sight vector in a time zone closest to a time at which the operation instruction has been input as an operation target device to be a target of the operation instruction.

7. The device operation apparatus according to claim 1,
wherein the text information is information for operation of the at least one operation target device, obtained by executing a voice recognition process and an interactive process on a voice stream corresponding to the acquired operation instruction.

8. A device operation system comprising:
the device operation apparatus according to claim 1;
the at least one operation target device for performing control of a function corresponding to the operation command transmitted from the device operation apparatus; and
a light emitting apparatus for transmitting a light emission signal to the device operation apparatus, the light emitting apparatus being disposed while being associated with the at least one operation target device,
wherein the processing circuitry of the device operation apparatus calculates a position of the at least one operation target device on a basis of the light emission signal transmitted by the light emitting apparatus.

9. A device operation method comprising:
acquiring information indicating a function of at least one operation target device including a plurality of operation target devices that are operation targets, as operation information;
calculating from image information on an image of a user who operates the plurality of operation target devices, the user's line-of-sight information;
calculating a position of each of the plurality of operation target devices using information transmitted from the plurality of operation target devices;
storing calculated position information of each of the operation target devices;
acquiring a voice signal indicating an operation instruction for operating each of the plurality of operation target devices;
specifying when the voice signal is acquired, the at least one operation target device to be a target of the operation instruction on a basis of the calculated line-of-sight information and the calculated and stored position information of each of the operation target devices; and
generating an operation command for controlling the at least one operation target device having been specified, on a basis of text information corresponding to the acquired operation instruction.
